(19) United States
(12) Patent Application Publication
(10) Pub. No.: US 2007/0216731 A1
(43) Pub. Date: Sep. 20, 2007

(54) Thermal head and printing device equipped with the same

(75) Inventors: Noboru Koyama, Tokyo (JP); Izumi Kariya, Kanagawa (JP); Mitsuo Yanase, Kanagawa (JP); Toru Morikawa, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/716,709

(22) Filed: Mar. 12, 2007

(30) Foreign Application Priority Data
Mar. 17, 2006 (JP) 2006-075639

(51) Int. Cl. B41J 2/05

(52) U.S. Cl. 347/56

(57) ABSTRACT

A thermal head includes a base layer having a predetermined thickness and provided with a substantially semicylindrical protruding section integrally formed on one surface of the base layer, a heat generation resistor formed on the protruding section, and a pair of electrodes formed on both sides of the heat generation resistor, wherein a part of each of the heat generation resistors exposed between the pair of electrodes is defined as a heat generation section, and the base layer is provided with a groove section formed on the opposite side of the protruding section and having opening on the other surface of the base layer.

### CROSS REFERENCES TO RELATED APPLICATIONS

The present invention contains subject matter related to Japanese Patent Application JP 2006-075639 filed in the Japan Patent Office on Mar. 17, 2006, the entire contents of which being incorporated herein by reference.

### BACKGROUND OF THE INVENTION

1. Technical Field

The present invention relates to a thermal head for thermal-transferring a color material on an ink ribbon to a print medium and a printing device.

2. Related Art

As a printing device for printing images or characters on a print medium, there is a thermal transfer printing device (hereinafter simply referred to as a printing device) which sublimates a color material forming an ink layer provided to one surface of an ink ribbon to thermal-transfer the color material to a print medium, thereby printing color images or characters. The printing device is provided with a thermal head for thermal-transferring the color material on the ink ribbon to the print medium and a platen disposed at a position facing the thermal head and for supporting the ink ribbon and the print medium. In the printing device, the ink ribbon and the print medium are overlapped so that the ink ribbon faces the thermal head side and the print medium faces the platen side, and the ink ribbon and the print medium run between the thermal head and the platen while the platen presses the ink ribbon and the print medium against the thermal head. In this case, the printing device applies thermal energy to the ink ribbon running between the thermal head and the platen with the thermal head on the ink layer from the rear face side of the ink ribbon, and sublimates the color material with the thermal energy to thermal-transfer the color material to the print medium, thereby printing color images or characters.

Incidentally, as a thermal head used for this kind of printing device, there is cited what is disclosed in a document of JP-A-8-216443. As shown in FIG. 18, the thermal head 100 is composed mainly of a ceramic substrate 101, a flat glaze layer 102a and a partial glaze layer 102b made of glass and formed on the ceramic substrate 101, and a heat generation resistor 103 formed on the partial glaze layer 102b. Further, a signal electrode 104a is provided on one end of the heat generation resistor 103 while a common electrode 104b is formed on the other end thereof. Further, an abrasion resistant layer 105 is formed on a part of the heat generation resistor 103 between the electrodes 104a, 104b, and the electrodes 104a, 104b. Further, the ceramic substrate 101 is bonded to a heat radiation member 107 with an adhesion layer 106.

Since the thermal head 100 described above is for applying thermal energy to the ink ribbon to thermal-transfer the color material to the print medium in the printing process, it is required to achieve improvement of thermal efficiency, and for this purpose, the heat radiation member is provided with a gap section 108 formed on the side of the ceramic substrate 101. In the thermal head 100, thermal conduction to the heat radiation member 107 is reduced by providing the gap section 108 to improve the heat storing property around the heat generation resistor 103, thus achieving the improvement of the thermal efficiency.

However, although the improvement of the thermal efficiency can be achieved with the thermal head 100 of the above document, it requires an extremely complicated manufacturing process because it is composed of the ceramic substrate 101, the flat glaze layer 102a and the partial glaze layer 102b formed on the ceramic substrate 101, and the heat generation resistor 103 formed on the partial glaze layer 102b, and further the ceramic substrate 101 provided with these components is bonded to the heat radiation member 107 via the adhesion layer 106, thus making it difficult to achieve further improvement of manufacturing efficiency.

### SUMMARY

Therefore, it is desirable to provide a thermal head capable of achieving improvement of the manufacturing efficiency and a printing device using the same.

Further, it is also desirable to provide a thermal head capable of further achieving improvement of the response while achieving improvement of the thermal efficiency and a printing device using the same.

Still further, it is also desirable to provide a thermal head capable of achieving improvement of the physical strength and a printing device using the same.

According to an embodiment of the present invention, there is provided a thermal head including a base layer having a predetermined thickness and provided with a substantially semicylindrical protruding section integrally formed on one surface of the base layer, a heat generation resistor formed on the protruding section, and a pair of electrodes provided to both sides of the heat generation resistor. In this case, a part of each of the heat generation resistors exposed between the pair of electrodes is defined as a heat generation section, and the base layer is provided with a groove section formed on the opposite side of the protruding section and having opening on the other surface of the base layer.

Further, according to another embodiment of the invention, there is provided a printing device equipped with the thermal head as described above.

According to the embodiments of the invention, by forming the groove section in the base layer, it becomes difficult to radiate heat from the other surface of the base layer, thus improvement of the thermal efficiency can be achieved, and further, the heat storage capacity of the base layer is reduced, thus improvement of the response can also be achieved. Further, according to the embodiments of the invention, since it is sufficient to adhere the head section provided with the heat generation resistor and the electrodes on the base layer to the heat radiation member, the ceramic substrate in the related art can be eliminated, thus simplification of the configuration can be achieved, and improvement of the production efficiency can also be achieved.

### BRIEF DESCRIPTION OF THE DRAWINGS

FIG. 1 is a schematic diagram of a printing device using a thermal head applying an embodiment of the invention.

FIG. 2 is a perspective view showing a relationship between the thermal head and a ribbon guide.

FIG. 3 is a perspective view of the thermal head.

FIG. 4 is a perspective view of the thermal head.

FIG. 5 is a cross-sectional view of a head section.

FIG. 6 is a plan view of the head section.

FIG. 7 is a cross-sectional view of a base layer.

FIG. 8 is a cross-sectional view of a head section according to a modified example of the head section shown in FIG. 5, in which the groove section has a width increasing from the side of the ceiling face towards the side of the open end.

FIG. 9A is a plan view of a glass layer provided with reinforcing sections, and FIG. 9B is a cross-sectional view thereof.

FIG. 10 is across-sectional view of the glass layer shown in FIGS. 9A and 9B.

FIG. 11 is a cross-sectional view showing a glass material to be the material of the glass layer.

FIG. 12 is a cross-sectional view showing the glass layer.

FIG. 13 is a cross-sectional view showing a condition in which a heat generation resistor and a pair of electrodes are patterned on the glass layer.

FIG. 14 is a cross-sectional view showing a condition in which a resistor protective layer is provided on the heat generation resistor and the pair of electrodes.

FIG. 15 is a cross-sectional view showing a condition in which a groove section is in a process of formation using a cutter.

FIG. 16 is a perspective view of the thermal head.

FIG. 17 is a cross-sectional view showing a condition in which the glass layer is adhered to a heat radiation member with an adhesive layer.

FIG. 18 is a cross-sectional view of a thermal head in the related art.

### DESCRIPTION OF THE EMBODIMENTS

Hereinafter, a thermal transfer printing device implementing a thermal head applying an embodiment of the invention will be explained in detail with reference to the accompanying drawings.

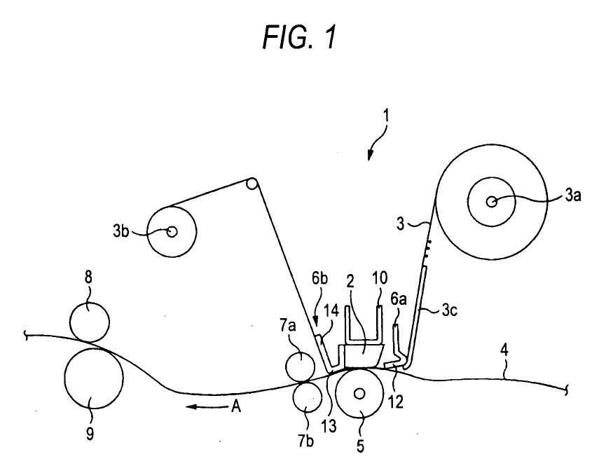

A thermal transfer printing device 1 (hereinafter referred to as a printing device 1) shown in FIG. 1 is a dye sublimation printer for sublimating a color material of an ink ribbon to thermal-transfer the color material to a print medium, and uses a thermal head 2 applying an embodiment of the invention as a recording head. The printing device 1 applies thermal energy generated by the thermal head 2 to the ink ribbon 3, thereby sublimating the color material of the ink ribbon 3 to thermal-transfer the color material of the ink ribbon 3 to the print medium 4, thus printing color images or characters. The printing device 1 is a home-use printing device, and is able to print on objects of, for example, a post card size as the print medium 4.

The ink ribbon 3 used here is formed of a long resin film, and is housed in an ink cartridge in a condition in which the part of the ink ribbon 3 not yet used in the thermal transfer process is wound around a supply spool 3a while the part of the ink ribbon 3 already used in the thermal transfer process is wound around a winding spool 3b. The ink ribbon 3 is provided with a transfer layer 3c repeatedly formed in a plane on one side of the long resin film, the transfer layer 3c being composed of an ink layer formed of a yellow color material, an ink layer formed of a magenta color material, an ink layer formed of a cyan color material, and a laminate layer formed of a laminate film to be thermal-transferred on the print medium 4 for improving stability of images or characters printed on the print medium 4.

As shown in FIG. 1, the printing device 1 is provided with a thermal head 2, a platen 5 disposed at a position facing the thermal head 2, a plurality of ribbon guides 6a, 6b for guiding running of the ink ribbon 3 mounted thereon, a pinch roller 7a and a capstan roller 7b for running the print medium 4 together with the ink ribbon 3 between the thermal head 2 and the platen 5, an ejection roller 8 for ejecting the print medium 4 on which printing has been performed, and a feed roller 9 for carrying the print medium 4 towards the thermal head 2.

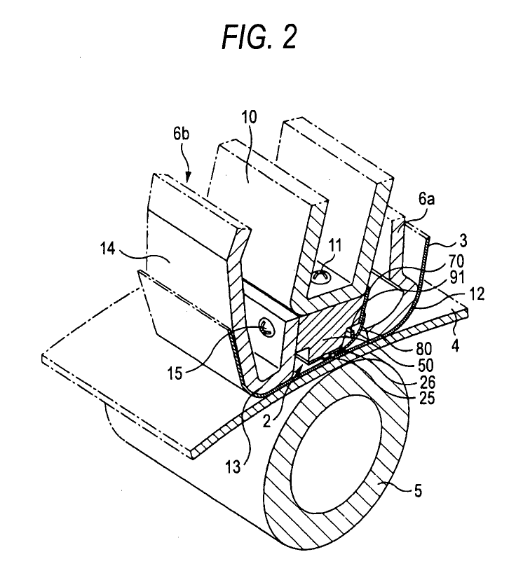

As shown in FIG. 2, the thermal head 2 is attached to an attachment member 10 on the housing of the printing device 1 side with a fixing member 11 such as a screw. The ribbon guides 6a, 6b for guiding the ink ribbon 3 are disposed in front of and behind the thermal head 2, namely, on the side from which the ink ribbon 3 enters and on the side to which the ink ribbon 3 is ejected with respect to the thermal head 2. The ribbon guides 6a, 6b guide the ink ribbon 3 and the print medium 4 in front of and behind the thermal head 2 so that the ink ribbon 3 and the print medium 4 overlapping each other abut on the thermal head 2 substantially perpendicular to each other, thus the thermal energy of the thermal head 2 can surely be applied to the ink ribbon 3.

The ribbon guide 6a is disposed on the side from which the ink ribbon 3 enters with respect to the thermal head 2. The ribbon guide 6a has a curved surface in the lower end surface 12, and guides the ink ribbon 3 supplied from the supply spool 3a disposed above the thermal head 2 to enter between the thermal head 2 and the platen 5. The ribbon guide 6b is disposed on the side to which the ink ribbon 3 is ejected with respect to the thermal head 2. The ribbon guide 6b has a flat section 13 evenly formed on the lower end and a separation section 14 rising substantially perpendicular from the end of the flat section 13 opposite the thermal head 2 and for breaking away the ink ribbon 3 from the print medium 4. The ribbon guide 6b removes the heat of the ink ribbon 3 after the thermal transfer process by the flat section 13, and then raises the ink ribbon 3 substantially perpendicular to the print medium 4 by the separation section 14 to break away the ink ribbon 3 from the print medium 4. The ribbon guide 6b is attached to the thermal head 2 with a fixing member 15 such as a screw.

In the printing device 1 having such a configuration, as shown in FIG. 1, the winding spool 3b is rotated in a winding direction to run the ink ribbon 3 in the winding direction, and the print medium 4 is pinched between the pinch roller 7a and the capstan roller 7b and runs in an ejection direction by rotating the capstan roller 7b and the ejection roller 8 in the ejection direction (the direction of arrow A in FIG. 1) between the thermal head 2 and the platen 5 while pressing the platen 5 against the thermal head 2. When performing printing, thermal energy is firstly applied from the thermal head 2 to the yellow ink layer of the ink ribbon 3 to thermal-transfer the yellow color material to the print medium 4 running while overlapping the ink ribbon 3, subsequently the magenta color material is thermal-transferred to the image forming section to which the yellow color material is thermal-transferred, then the cyan color material is thermal-transferred to the image forming section to which the yellow and magenta color materials are thermal-transferred, and finally the laminate film is thermal-transferred to complete printing of color images or characters.

The thermal head 2 used for such a printing device 1 can print a framed image having margins on both edges in a direction perpendicular to the running direction of the print medium 4, namely the width direction of the print medium 4, and also a frameless image without the margins.

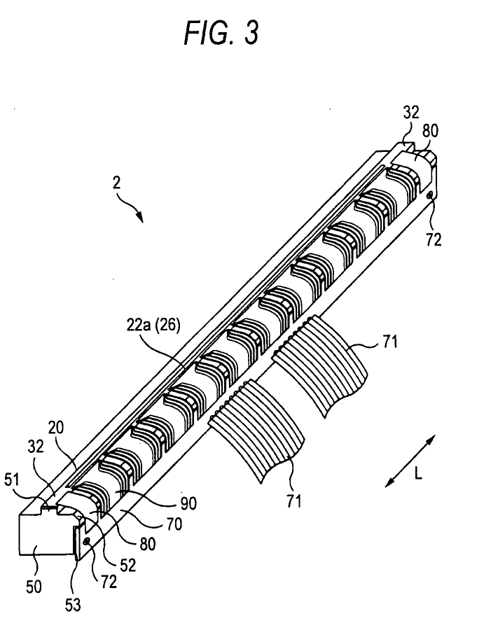

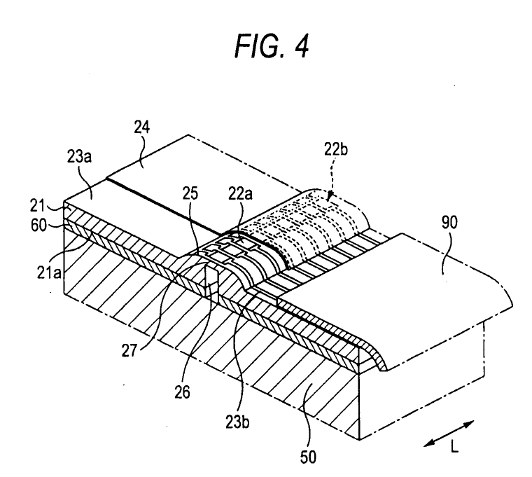

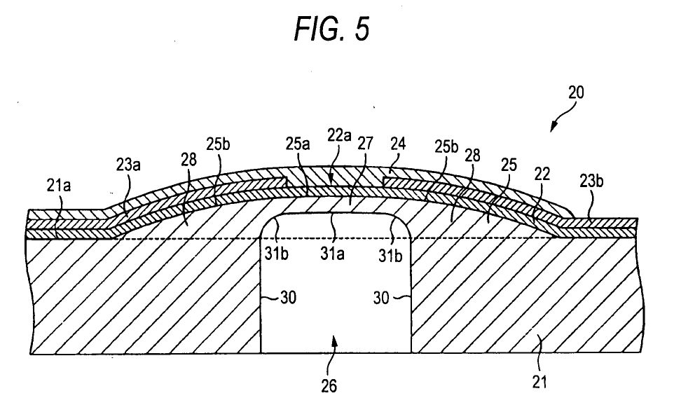

The thermal head 2 is formed to have a size in a direction designated by the direction of the arrow L shown in FIG. 3 larger than the width of the print medium 4 so that the color material can be thermal-transferred to the both edges of the print medium 4 in the width direction thereof. As shown in FIG. 3, the thermal head 2 is provided with a head section 20 attached to a heat radiation member 50 for thermal-transferring the color material of the ink ribbon 3 to the print medium 4. As shown in FIGS. 4 and 5, the head section 20 is provided with a base layer 21 made of glass, a heat generation resistor 22 disposed on the base layer 21, a pair of electrodes 23a, 23b disposed on both sides of the heat generation resistor 22, and a resistor protective layer 24 disposed on and the periphery of the heat generation resistor 22. In the thermal head 2, a part of the heat generation resistor 22 exposed between the pair of electrodes 23a, 23b is defined as a heat generation section 22a.

As shown in FIGS. 4 and 5, the base layer 21 is provided with a protruding section 25 made of glass having a softening point of, for example, of about 500° C. and formed integrally therewith to have a substantially rectangular shape on one surface 21a thereof facing the ink ribbon 3 so as to have a substantially semicylindrical shape, and a groove section 26 is provided on the opposite side to the protruding section 25 having an open end on the other surface of the base layer 21. In the base layer 21, by forming the protruding section 25 at substantially the center thereof in the width direction of the base layer 21 and in the length direction (the L direction in FIG. 2) so as to have a substantially semicylindrical shape, the contact condition with the in ribbon 3 running thereon is improved, thus the thermal energy is surely applied to the ink ribbon 3 running thereon to make the color materials be thermal-transferred to the print medium 4. In other words, as windshields of automobiles are slightly curved to obtain preferable water flip property, in this case, the protruding section 25 is formed to have a substantially semicylindrical shape so as to make it possible to surely thermal-transfer the color materials of the ink ribbon 3 to the print medium 4.

As shown in FIGS. 4 and 5, the groove section 26 provided to the inner surface of the base layer 21 is formed to have a concave shape facing a line 22b of the heat generation sections 22a disposed substantially linearly on the protruding section 25, thus forming a gap section inside the base layer 21. Further, in the base layer 21, a heat storage section 27 for storing the thermal energy generated by the heat generation section 22a is defined between the front surface 25a of the protruding section 25 and the ceiling surface 31a of the groove section 26.

The base layer 21 has a configuration in which by forming the gap section with the groove section 26 inside the base layer 21, the air inside the groove section 26 makes it difficult to radiate the thermal energy generated by the heat generation section 22a inside the base layer 21, thus it becomes easy to efficiently apply the thermal energy to the ink ribbon 3. On the other hand, the heat storage section 27 becomes thinner to reduce the heat storage capacity by forming the groove section 26 inside the base layer 21, thus the heat radiation can be performed in a short period of time. As described above, since the heat storage capacity of the base layer 21 provided with the groove section 26 is reduced, the heat radiation becomes to be able to be performed in a short period of time, thus the response of the thermal head 2 can be improved, and further, since the base layer 21 has a configuration in which the heat is difficult to be radiated, the thermal efficiency can be improved, thus the power consumption of the thermal head 2 can be reduced.

It should be noted that it is sufficient that the base layer 21 is made of a material having a predetermined surface property, a thermal characteristic, and so on represented by glass, and can also be made of a synthetic gem or an artificial stone such as synthetic quartz, synthetic ruby, or synthetic sapphire, or a high-density ceramic besides the glass mentioned here.

The heat generation resistor 22 formed on the base layer 21 described above is disposed on one surface of the base layer 21 as shown in FIG. 5. The heat generation resistor 22 is made of a material having high electrical resistivity and heat resistance such as Ta—N or Ta—SiO₂. The heat generation resistor 22 is provided with a pair of electrodes 23a, 23b formed on the both sides thereof. The pair of electrodes 23a, 23b supply the heat generation section 22a with a current from a power supply not shown in detail to make the heat generation section 22 generate heat. The pair of electrodes 23a, 23b are made of a material having good electrical conductivity such as aluminum, gold, or copper. A gap between the pair of electrodes 23a, 23b exposes the heat generation resistor 22 to define the heat generation section 22a for applying the thermal energy to the ink ribbon 3. The heat generation sections 22a are formed substantially linearly on the protruding section 25, and each formed to have a substantially rectangular or square shape slightly larger than the dot size.

It should be noted that the area in which the heat generation resistors 22 are formed is not necessarily provided on the entire surface of the one surface 21a of the base layer 21 providing the area is sufficiently larger than the area to be the heat generation section 22a for electrically connecting to the pair of electrodes 23a, 23b.

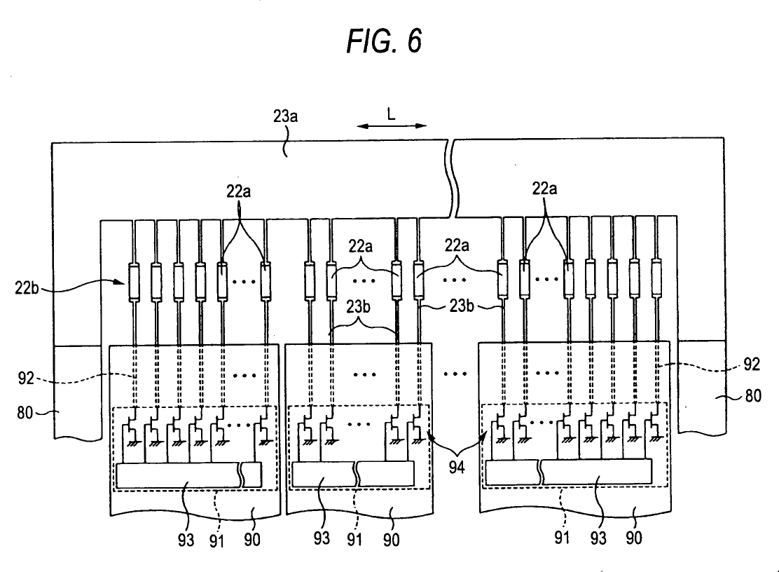

As shown in FIGS. 3 and 6, the pair of electrodes 23a, 23b are composed of a common electrode 23a electrically connected to all of the heat generation sections 22a and an individual electrode 23b electrically connected individually to every heat generation section 22a, and are formed on the heat generation resistor 22 distant from each other across the heat generation section 22a.

As shown in FIG. 6, the common electrode 23a is disposed on one side opposite to a side where a power supply flexible board 80 described below is bonded thereon across the protruding section 25 of the base layer 21. The common electrode 23a is electrically connected to all of the heat generation sections 22a, and has both ends led-out along the narrow sides of the base layer 21 to the sides where the power supply flexible boards 80 are bonded to be electrically connected to the power supply flexible boards 80, and further electrically connected via the power supply flexible boards 80 to the rigid board 70 electrically connected to a power supply not shown, thereby electrically connecting each of the heat generation sections 22a to the power supply.

As shown in FIG. 6, the individual electrode 23b is disposed on a side of the protruding section 25 of the base layer 21 where a signal flexible board 90 described below is bonded thereon. The individual electrode 23b is provided to the heat generation section 22a one-on-one. The individual electrode 23b is electrically connected to the signal flexible board 90 connected to a control circuit for controlling the drive of the heat generation section 22a of the rigid board 70.

The common electrode 23a and the individual electrode 23b supply the heat generation section 22a selected by a circuit for controlling drive of the heat generation section 22a with a current for a predetermined period of time, thereby making the heat generation section 22a generate heat to raise the temperature to a point enough for sublimating the color material to be thermal-transferred to the print medium 4.

As shown in FIGS. 4 and 5, the resistor protective layer 24 provided as the outer most layer of the head section 20 covers the entire heat generation resistors 22 and the common electrodes 23a, and the heat generation section 22a side end portions of the individual electrodes 23b, and protects the heat generation sections 22a and the pairs of electrodes 23a, 23b disposed around the heat generation sections 22a from the friction and so on caused when the thermal head 2 and the ink ribbon 3 come in contact with each other. The resistor protective layer 24 is made of an inorganic material containing metal excel in mechanical characteristic such as high-strength and abrasion resistance under high temperature and in thermal characteristic such as heat resistance, thermal shock resistance, and thermal conductivity, and is made of, for example, SIALON (a trade name) including silicon (Si), aluminum (Al), oxygen (O), and nitrogen (N). It should be noted that a similar layer to the resistor protective layer 24 can be provided to the groove section 26, specifically on the ceiling surface 31a.

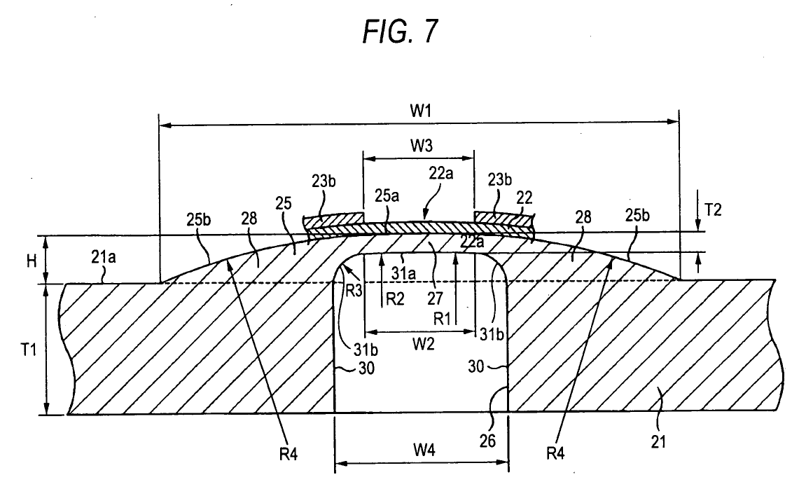

Here, the base layer 21 will be explained in detail with reference to FIG. 7. The base layer 21 has a substantially constant thickness T1 of, for example, 0.19 mm, and is provided with the protruding section 25 having a height H of, for example, 0.098 mm and a width W1 of, for example, 0.9 mm formed on the one surface 21a thereof.

The groove 26 of the base layer 21 is formed to have a depth with which the ceiling 31a thereof is positioned above the one surface 21a of the base layer 21, namely inside the protruding section 25 having a substantially semicylindrical shape. It should be noted that the dashed line in FIG. 5 illustrates an extension line of the one surface 21a of the base layer 21 inside the protruding section 25. The groove section 26 has the ceiling surface 31a positioned above the one surface of the base layer 21 to make the heat storage section 27 between the surface 25a of the protruding section 25 and the ceiling surface 31a of the groove section 26 thinner so as to reduce the heat storing capacity, thus achieving improvement of the response of the thermal head 2. It is obvious that the ceiling 31a can also be positioned below the protruding section 25 although less effective than in the case of the ceiling 31a positioning inside the protruding section 25.

Further, in the heat storage section 27, the surface 25a of the protruding section 25 is formed of an extremely gentle circular arc surface. For example, the surface 25a of the protruding section 25 is formed to have a radius R1 of 2.5 mm. On the other hand, the ceiling 31a of the groove section 26 is formed of a circular arc surface shaped substantially along the surface 25a of the protruding section 25. For example, the ceiling surface 31a of the groove section 26 is formed to have a radius R2 of 2.4725 mm. As described above, in the heat storage section 27, the surface 25a of the protruding section 25 and the ceiling surface 31a of the groove section 26 are formed of substantially the same circular arc surfaces so that the thickness T2 of the heat storage section 27 becomes substantially even. For example, the heat storage section 27 is formed to have the thickness T2 of 0.0275 mm. As described above, the heat storage section 27 is formed to have the substantially even thickness, thus the thermal energy can evenly be stored.

Incidentally, since the heat storage section 27 is formed to have a small thickness for reducing the heat storage capacity, the heat storage section 27 is required to have a physical strength enough for preventing damages caused by the pressure by the platen 5. As described above, since the heat storage section 27 has the substantially even thickness, stress concentration zones in the heat storage section 27 can be eliminated or at least reduced, thus making it possible to increase the physical strength. Further, the corner sections 31b defined between the sidewalls 30 and the ceiling surface 31a of the groove section 26 are formed to have circular arc curves. The corner sections 31b are each formed of a curved surface having a radius R3 of, for example, 0.03 mm. By forming the both corner sections 31b of the groove section 26 with the curves, the protruding section 25 can disperse the pressure applied by the platen 5 to the periphery better than, for example, in the case of the both corners 31b formed orthogonally, thus making it possible to increase the physical strength.

The width W2 of the heat storage section 27 having the substantially even thickness T2 is set to be the same as the width W3 of the heat generation section 22a which is a part of the heat generation resistor 22 exposed between the pair of electrodes 23a, 23b. Specifically, the width W2 of the heat storage section 27 is defined as a distance between the inner ends of the curves of the both corners 31b, and is set to be equal to the width W3 of the heat generation section 22a. For example, the inner ends of the curves of the both corners 31b are positioned 0.03 mm distant from the sidewalls 30 of the groove section 26, and the widths W2 and W3 are each set to be 0.2 mm. Thus, the heat generation section 22a is arranged to be positioned right above the heat storage section 27 having the substantially even thickness to substantially evenly storing the thermal energy, thus it becomes possible to evenly apply the thermal energy to the ink ribbon 3 from inside the area of the heat generation section 22a. It should be noted that the width W1 (0.9 mm in this case) of the protruding section 25 is preferably three or more times as large as the width W2 (0.2 mm in this case) of the heat storage section 27 with the substantially even thickness of T2 from a viewpoint of the physical strength and so on.

Further, the width W2 of the heat storage section 27 with the substantially even thickness T2 can also be set larger than the width W3 of the heat generation section 22a. Thus, since the thickness of a part of the heat storage section 27 on each side of the heat generation section 22a is reduced, namely the thermal conduction path is narrowed, it can be made difficult to radiate the thermal energy stored in the heat storage section 27 to the peripheral sections 28 of the protruding section 25.

Further, the both sides 25b of the heat storage section 27 are each formed to have a surface curvature radius R4 smaller than the radius R1 of the surface 25a of the protruding section 25 in a area in which the heat storage section 27 is formed. In other words, the curved surfaces on the both sides 25b of the curved surface in the surface 25a of the protruding section 25 are each formed of a sharper curved surface than the curved surface of the surface 25a of the part of the protruding section 25 formed in the heat storage section 27. Thus, it becomes possible to make the ink ribbon 3 easily enter or exit from the heat generation section 22a. Further, the protruding section 25 can be formed to have the smaller thickness of the heat storage section 27 on each side of the heat generation section 22a by forming each of the curved surfaces of the both sides 25b of the heat storage section 27 to have the smaller curvature radius R4 than the radius R1 of the surface 25a provided with the heat storage section 27, namely by forming each of the curved surfaces sharper, compared to the reverse case, thus it can be made difficult to radiate the thermal energy stored in the heat storage section 27 to the peripheral sections 28 of the protruding section 25.

Further, the sidewalls 30 of the groove section 26 are formed so as to rise substantially vertical from the other surface of the base layer 21 and to have a constant width W4 of, for example, 0.26 mm. Thus, concentration of the pressure to the rising points of the sidewalls 30 can be prevented even when the protruding section 25 is pressurized by the platen 5 compared to the case in which the groove section 26 is formed so as to increase the width thereof along a direction towards the opening side, thus the physical strength can be increased. It should be noted that the width W4 between the sidewalls 30 can be set equal to the width W2 of the heat storage section 27 if the both corner sections 31b of the groove section 26 are not provided with the curved surfaces, namely right angles are formed.

Here, the sizes of the thermal head 2, which are actually put into practice and shown in FIGS. 5 and 7, will now be explained. The width W4 of the groove section 26, which is equal to or larger than the width W3 of the heat generation section 22a, is, for example, in a range of 0.05 mm through 0.7 mm, preferably in a range of 0.2 mm through 0.7 mm, and further preferably 0.26 mm. Further, the thickness T2 of the heat storage section 27 is, for example, in a range of 0.01 mm through 0.1 mm, preferably in a range of 0.02 mm through 0.04 mm, and further preferably 0.0275 mm.

It should be noted that the groove section 26 can be provided with the sidewalls formed of inclined surfaces 30a so that the width gradually increases from that in the ceiling surface 31a. Thus, in the case of molding the groove section 26 by the thermal press molding using a press die, for example, demolding can be made easier, thus the production efficiency can be improved.

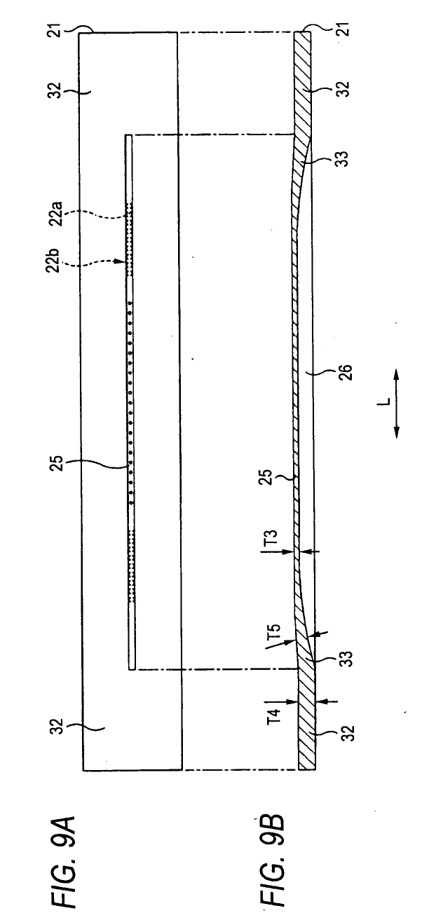

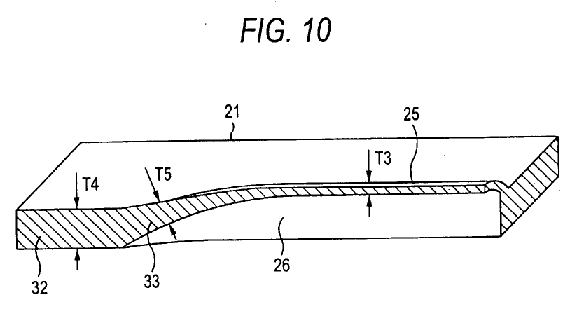

In the base layer 21 of the head section 20, as shown in FIGS. 9A, 9B and 10, the groove section 26 is provided so as to face the line 22b of the heat generation sections 22a substantially linearly arranged in parallel in the length direction (the L direction in FIG. 10) of the head section 20, and first reinforcement sections 32 for reinforcing the strength are provided on both sides of the heat generation sections 22a in the arranging direction of the heat generation sections 22a of the groove section 26. The first reinforcement sections 32 are provided by forming the base layer 21 so as to have a larger thickness. The thickness T4 of the first reinforcement section 32 is made larger than the thickness T3 of the protruding section 25 (T4>T3). Thus, the first reinforcement section 32 can reinforce the protruding section 25 in the both sides of the head section 20 in the length direction thereof.

Further, as shown in FIGS. 9A, 9B and 10, besides the first reinforcement sections 32, the base layer 21 is provided with second reinforcement sections 33 each formed inside the first reinforcement sections 32 so as to have a thickness T5 gradually increases along the direction from the end portion of the protruding section 25 towards the first reinforcement section 32. Thus, in the base layer 21, the protruding section 25 is arranged to be further reinforced by providing the second reinforcement sections 33 in addition to the first reinforcement sections 32.

As described above, by forming the first reinforcement sections 32 and the second reinforcement sections 33 along the length direction, the head section 20 can be increased in the physical strength, thus the deformations and the breakages of the protruding sections 25 caused by the pressure from the platen 5 can be prevented.

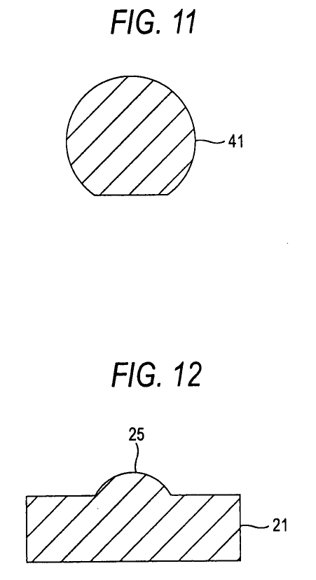

The head section 20 having the base layer 21 can be manufactured as described below. Firstly, as shown in FIG. 11, a glass material 41 to be used as the material of the base layer 21 is prepared, and then as shown in FIG. 12, by performing a thermal press process on the glass material 41 to mold the base layer 21 having the protruding section 25 on the upper surface thereof.

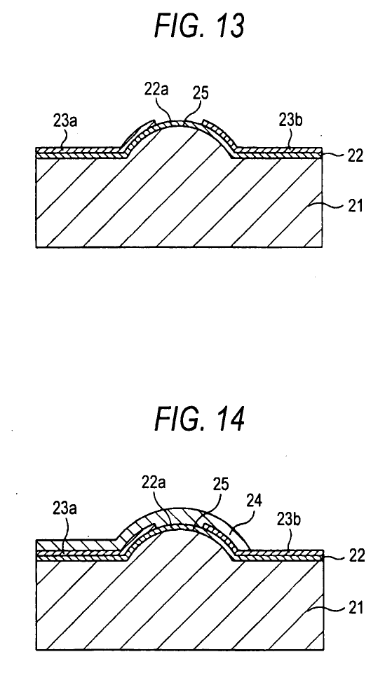

Subsequently, as shown in FIG. 13, the resistor film to form the heat generation resistor 22 is formed on the surface of the base layer 21 provided with the protruding section 25 with a material having high resistivity and thermal resistance using a thin film forming technology such as sputtering, and further, a conductive film to form the pair of electrodes 23a, 23b is then formed on the heat generation resistor 22 with a material having good electrical conductivity such as aluminum so as to have a predetermined thickness.

Subsequently, as shown in FIG. 14, the heat generation resistor 22 and the pair of electrodes 23a, 23b are patterned using a pattern forming technology such as a photolithography process, and the heat generation section 22a is formed by exposing the heat generation resistor 22 between the pair of electrodes 23a, 23b. The base layer 21 is exposed in the portion where either the heat generation resistor 22 or the pair of electrodes 23a, 23b is not formed.

Subsequently, as shown in FIG. 14, the resistor protective layer 24 is formed on the heat generation resistor 22 and the pair of electrodes 23a, 23b with, for example, SIALON in a predetermined thickness using a thin film forming technology such as a sputtering process.

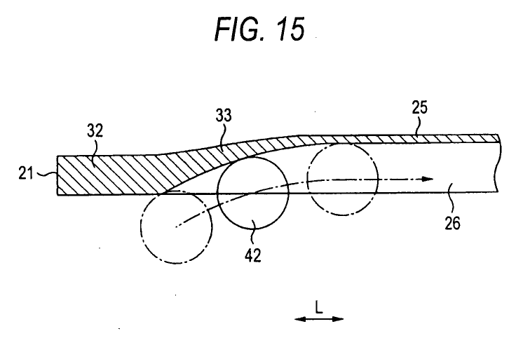

Subsequently, as shown in FIG. 15, the groove section 26 having a concave shape is formed on a surface opposite the surface of the base layer 21 on which the protruding section 25 is formed, namely the surface to be located inside the thermal head 2 by, for example, cutting with a cutter 42 so as to face the line 22b of the heat generation sections 22a. As shown in FIG. 15, by forming the groove section 26 with the cutter 42, the first reinforcement sections 32 and the second reinforcement sections 33 can be provided to the base layer 21 in a series of cutting processes.

It should be noted that after forming the groove section 26 by the cutting process, a hydrofluoric acid treatment can be performed on the inner surface of the groove section 26 in order for removing scratches caused on the inner surface of the groove section 26. Further, the groove section 26 can be formed by an etching process or a thermal press process besides the machining process such as a cutting process.

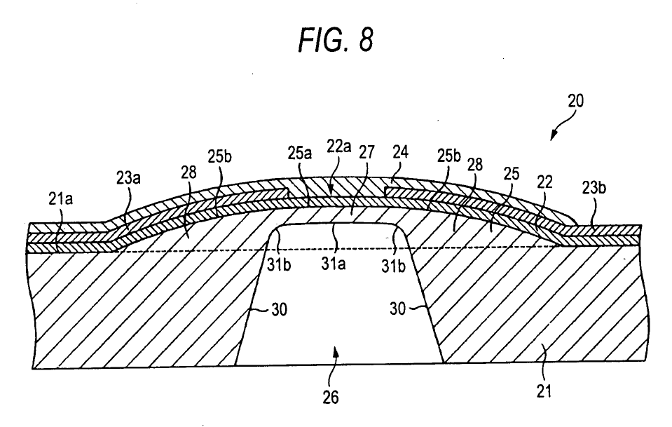

Further, as shown in FIG. 8, in the case of forming the sidewalls 30 of the groove section 26 with the inclined surfaces 30a, since the sidewalls 30 broaden from the ceiling surface 31a towards the opening side, demolding becomes easier, and accordingly, the groove 26 can be formed by the thermal press process using a press die. Still further, in the case of forming the groove section 26 by the thermal press process, it is possible to form the protruding section 25 with an upper die and to form the groove section 26 with a lower die, thus simultaneously forming the protruding section 25 and the groove section 26.

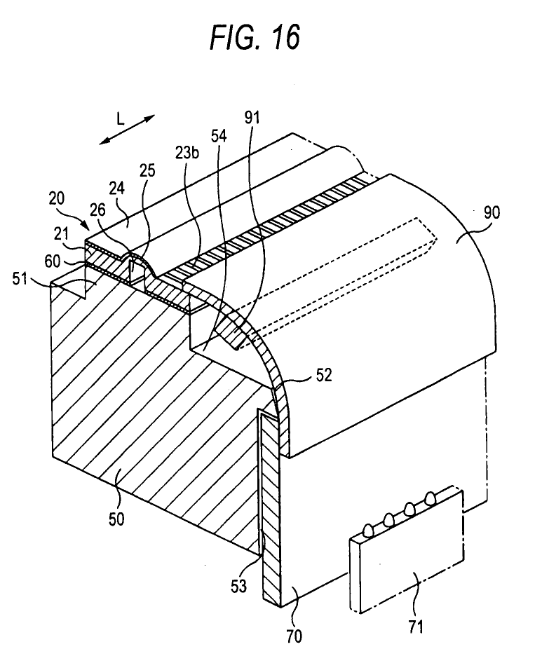

As shown in FIGS. 3 and 16, in the thermal head 2 having the head section 20 described above, the head section 20 is disposed on the heat radiation member 50 via an adhesive layer 60, and the head section 20 and the rigid board 70 provided with a control circuit for the head section 20 are electrically connected to each other with the power supply flexible boards 80 and the signal flexible boards 90. In the thermal head 2, the rigid board 70 is disposed on the side face of the heat radiation member 50 by bending the power supply flexible boards 80 and the signal flexible boards 90 towards the heat radiation member 50, thus achieving miniaturization.

The heat radiation member 50 is for radiating the thermal energy generated by the head section 20 when thermal-transferring the color material, and is made of a material having high thermal conductivity such as aluminum. As shown in FIGS. 3 and 16, the heat radiation member 50 is provided with an attachment protruding section 51 to which the head section 20 is attached formed on the upper surface at substantially the center in the width direction, and along the length direction (the L direction in FIG. 16). Further, the heat radiation member 50 is provided with an inclined section 52 for guiding the power supply flexible board 80 and the signal flexible board 90 bending along the side surface formed at the upper end of the side surface towards which the power supply flexible board 80 and the signal flexible board 90 bend, and a first notch section 53 for positioning the rigid board 70 formed at the lower end of the inclined section 52. Further, the heat radiation member 50 is provided with a second notch 54 formed so as to allow a semiconductor chip 91 described later provided to the signal flexible board 90 to be disposed on the side of the heat radiation member 50.

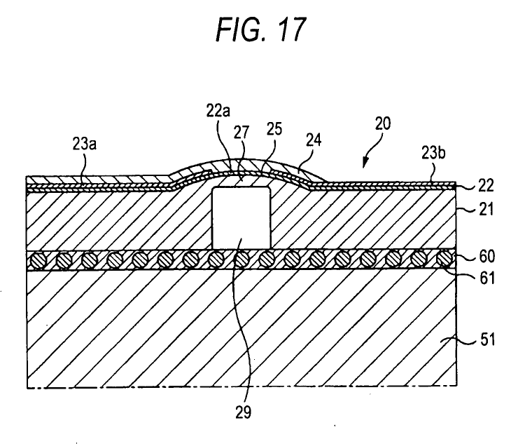

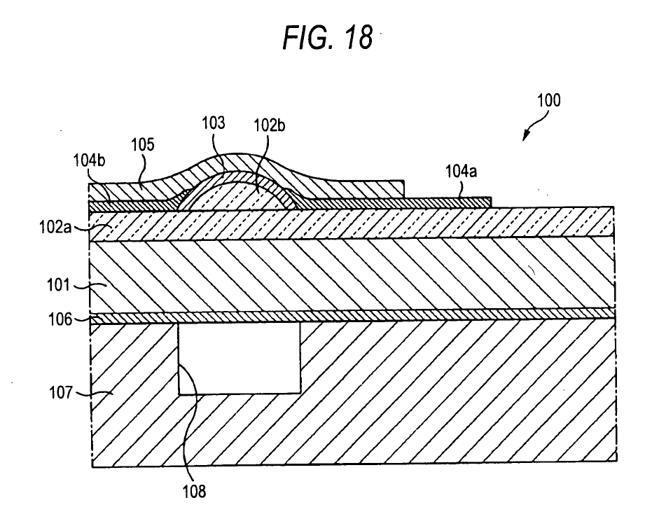

As shown in FIG. 17, the head section 20 is attached to the attachment protruding section 51 of the heat radiation member 50 via the adhesive layer 60. As the adhesive layer 60, an adhesive superior in the thermal conductivity and having elasticity is selectively used. Since the adhesive layer 60 has thermal conductivity, the heat generated by the head section 20 can efficiently be radiated to the heat radiation member 50, and since the adhesive layer 60 has elasticity, the head section 20 can be prevented from being broken away from the heat radiation member 50 when the head section 20 generates the heat even if the head section 20 and the heat radiation member 50 expand or shrink differently from each other because of the difference in the thermal expansion coefficients of the heat radiation member 50 and the head section 20. The thickness of the adhesive layer 60 is, for example, about 50 μm.

As shown in FIG. 17, the adhesive layer 60 is made of resin having thermal conductivity such as thermoset liquid silicone rubber containing a filler 61 having high hardness and thermal conductivity. The filler 61 contained therein is, for example, aluminum oxide of granulated or linear shapes. The adhesive layer 60 contains the filler 61 which functions as a spacer between the head section 20 and the heat radiation member 50, and accordingly, is not compressed by the head section 20 which is pressed by the platen 5, thus maintaining the constant thickness so that the base layer 21 is not deformed towards the heat radiation member 50. Thus, the head section 20 can prevent the tension from being concentrated to the both sides of the groove section 26 even when the pressure is applied from the platen 5, and further the pressure applied by the platen 5 can be deflected in the parallel direction by the rotational movement of the filler 61.

The rigid board 70 disposed on the side surface of the heat radiation member 50 shown in FIG. 3 is provided with power supply wiring not shown and for supplying current from the power supply to the head section 20 and the control circuit not shown, provided with a plurality of electronic components mounted thereon, and for controlling driving of the head section 20. As shown in FIG. 3, flexible boards 71 to form power supply lines and signal lines are electrically connected to the rigid board 70. The rigid board 70 is disposed in the first notch 53 on the side face of the heat radiation member 50 and is fixed to the heat radiation member 50 on the both ends with fixing members 72 such as screws.

As shown in FIGS. 3 and 6, the power supply flexible board 80 electrically connected to the rigid board 70 is electrically connected to wiring for power supply not shown of the rigid board 70 on one end thereof, and is electrically connected to the common electrodes 23a of the head section 20 on the other end thereof, thereby electrically connecting the common electrodes 23a of the head section 20 and the wiring of the rigid board 70 to each other to supply each of the heat generation sections,22a with the current.

Further, as shown in FIGS. 3 and 6, the signal flexible board 90 electrically connected to the control circuit of the rigid board 70 is electrically connected to the control circuit not shown of the rigid board 70 on one end thereof, and is electrically connected to the individual electrodes 23b of the head section 20 on the other end thereof.

As shown in FIGS. 6 and 16, each of the signal flexible boards 90 is provided with a semiconductor chip 91 provided with a drive circuit for driving each of the heat generation sections 22a of the head section 20 disposed on one surface thereof, and is provided with connection terminals 92 for electrically connecting the semiconductor chip 91 and each of the individual electrodes 23b disposed on the same surface and on the side of connection with the head section 20.

The semiconductor chip 91 provided to each of the signal flexible boards 90 is, as shown in FIG. 16, disposed inside the signal flexible board 90. As shown in FIG. 6, the semiconductor chip 91 includes a shift register 93 for converting a serial signal corresponding to the print data transmitted from the control circuit of the rigid board 70 into a parallel signal, and a switching element 94 for controlling driving of heat generation of the heat generation section 22a. The shift register 93 converts the serial signal corresponding to the print data into a parallel signal, and latches the converted parallel signal. The switching element 94 is provided to every individual electrode 23b disposed to each of the heat generation sections 22a. The parallel signal latched by the shift register 93 controls switching on/off of the switching element 94 to control the current and the supply time period to each of the heat generation sections 22a, thus driving and controlling the heat generation of the heat generation sections 22a.

As described above, according to the thermal head 2, by disposing the semiconductor chips 91 having the shift register 93 for converting a serial signal into a parallel signal on the signal flexible boards 90 for electrically connecting the individual electrodes 23b of the head section 20 and the control circuit of the rigid board 70, serial transmission can be used between the rigid board 70 and the signal flexible boards 90, thus the number of electrical connection points can be reduced.

As shown in FIGS. 3 and 16, in the thermal head 2 with the configuration described above, the semiconductor chips 91 are faced the second notch 54 of the heat radiation member 50, and the power supply flexible boards 80 and the signal flexible boards 90 are bent along the inclined section 52 of the heat radiation member 50 so that the semiconductor chips 91 come inside, thus the rigid board 70 is positioned in the first notch 53 of the heat radiation member 50. Thus, in the thermal head 2, miniaturization can be achieved by disposing the rigid board 70 on the side face of the heat radiation member 50, and accordingly, the whole printing device 1 can be downsized. Therefore, with the thermal head 2, downsizing required to the printing device 1, particularly to home-use printing devices can be realized. Further, in the thermal head 2, the head section 20 can simply be provided on the heat radiation member 50 via the adhesive layer 60, the configuration can be simplified, and it can easily be manufactured, thus the production efficiency can be improved. Further, in the thermal head 2, miniaturization is possible by disposing the semiconductor chips 91 inside, and disposing the rigid board 70 on the side face of the heat radiation member 50, and accordingly, as shown in FIGS. 1 and 2, the ribbon guide 6a in the entrance side of the print medium 4 can be disposed closer to the thermal head 2. Thus, the printing device 1 using the thermal head 2 can guide the ink ribbon 3 and the print medium 4 to a position immediately before entering the gap between the thermal head 2 and the platen 5, thus it is possible to make the ink ribbon 3 and the print medium 4 appropriately enter the gap between the thermal head 2 and the platen 5. Therefore, in the printing device 1, since it is possible to make the ink ribbon 3 and the print medium 4 appropriately enter the gap between the thermal head 2 and the platen 5, it becomes that the ink ribbon 3 and the print medium 4 make substantially the right angle with the thermal head 2, thus the thermal energy of the thermal head 2 is appropriately applied to the ink ribbon 3.

As shown in FIGS. 1 and 2, when printing images or characters, the printing device 1 using the thermal head 2 described above runs the ink ribbon 3 and the print medium 4 between the thermal head 2 and the platen 5 while pressing the ink ribbon 3 and the print medium 4 against the thermal head 2 by the platen 5. Then, the color material of the ink ribbon 3 is thermal-transferred to the print medium 4 running between the thermal head 2 and the platen 5. When performing the thermal transfer of the color material, the serial signal corresponding to the print data and transmitted to the control circuit of the rigid board 70 is converted into the parallel signal by the shift registers 93 of the semiconductor chips 91 provided to the signal flexible boards 90, the parallel signals thus converted are latched, and the on/off control of the switching element 94 provided for every individual electrode 23b are performed in accordance with the latched parallel signals. In the thermal head 2, when the switching element 94 is switched on, a current flows through the heat generation section 22a connected to the switching element 94 for a predetermined period of time, the heat generation section 22a generates heat, and the thermal energy thus generated is applied to the ink ribbon 3, thus the color material is sublimated to be thermal-transferred to the print medium 4. Further, when the switching element 94 is switched off, the current flowing through the heat generation section 22a connected to the switching element 94 stops, since the heat generation section 22a stops generating the heat, the thermal energy is not applied to the ink ribbon 3, and accordingly the color material is not thermal-transferred to the print medium 4. In the printing device 1, the serial signal for every one line of the print data is transmitted from the control circuit of the thermal head 2 to the semiconductor chips 91 of the signal flexible boards 90, and the yellow color material is thermal-transferred to the image forming section by repeating the operation described above. After thermal-transferring the yellow color material, the magenta and cyan color materials and the laminate film are sequentially thermal-transferred to the image forming section in the similar manner, thus a frame of image is printed.

Since the groove section 26 is provided to the base layer 21 of the head section 20 of the thermal head 2, when the color material of the ink ribbon 3 is thermal-transferred, the air in the groove section 26 makes it difficult to radiate the thermal energy generated by the heat generation section 22a to the inside thereof, thus the thermal energy can efficiently be applied to the ink ribbon 3. On the other hand, the heat storage section 27 becomes thinner to reduce the heat storage capacity by forming the groove section 26 inside the base layer 21, thus the heat radiation can be performed in a short period of time. As described above, since the heat storage capacity of the base layer 21 provided with the groove section 26 is reduced, the heat radiation becomes to be able to be performed in a short period of time, thus the response of the thermal head 2 can be improved, and further, since the base layer 21 has a configuration in which the heat is difficult to be radiated, the thermal efficiency can be improved, thus the power consumption of the thermal head 2 can be reduced. Further, since the head section 20 is configured by forming the heat generation resistors 22, the pairs of electrodes 23a, 23b, and so on integrally on the base layer 21, and the thermal head 2 is configured by attaching the head section 20 to the heat radiation member 50 via the adhesive layer 60, the simplification of the overall configuration can be achieved, thus improvement of the productivity can be achieved. Further, since in the thermal head 2, the rigid board 70 is disposed on the side face of the heat radiation member 50 with the power supply flexible boards 80 and the signal flexible boards 90 to electrically connect the head section 20 and the rigid board 70 to each other, miniaturization can be achieved, and further, it becomes possible to contribute to the miniaturization of the overall printing device 1.

It should be noted that although the thermal head 2 is exemplified in the case of printing postcards with the home-use printing device 1, it is not limited to the home-use printing device 1, but can be applied to a business-use printing device, the size is not particularly limited, it can also be applied to L-size photo paper or plain paper in addition to the postcards, and it can achieve high speed printing even in these cases.

It should be understood by those skilled in the art that various modifications, combinations, sub-combinations and alterations may occur depending on design requirements and other factors insofar as they are within the scope of the appended claims or the equivalents thereof.

What is claimed is:

1. A thermal head comprising:
a base layer having a predetermined thickness and provided with a substantially semicylindrical protruding section integrally formed on one surface of the base layer;
a heat generation resistor formed on the protruding section; and
a pair of electrodes formed on both sides of the heat generation resistor,
wherein a part of each of the heat generation resistors exposed between the pair of electrodes is defined as a heat generation section, and
the base layer is provided with a groove section formed on the opposite side of the protruding section and having opening on the other surface of the base layer.

2. The thermal head according to claim 1
wherein a ceiling surface of the groove section is positioned inside the protruding section.

3. The thermal head according to claim 1
wherein the ceiling surface of the groove section is formed along a surface of the protruding section to make a thickness between the ceiling surface of the groove section and the surface of the protruding section substantially constant.

4. The thermal head according to claim 3
wherein a width of an area in which the thickness between the ceiling surface of the groove section and the surface of the protruding section is substantially constant is one of equal to and larger than a width of the heat generation section.

5. The thermal head according to claim 1
wherein the groove section is provided with a corner section defined by the ceiling surface and a sidewall of the groove section formed of a substantially circular arc curved surface.

6. The thermal head according to claim 1
wherein a width of the groove section is substantially constant throughout a range from a ceiling surface side to an opening end side.

7. The thermal head according to claim 1
wherein a width of the groove section is broadened along a direction from a ceiling surface side to an opening end side.

8. A printing device comprising
a thermal head having
a base layer having a predetermined thickness and provided with a substantially semicylindrical protruding section formed on one surface of the base layer,
a heat generation resistor formed on the protruding section, and
a pair of electrodes provided to both sides of the heat generation resistor,
wherein a part of each of the heat generation resistors exposed between the pair of electrodes is defined as a heat generation section, and
the base layer is provided with a groove section formed on the opposite side of the protruding section and having opening on the other surface of the base layer.
